(19) United States
(12) Patent Application Publication
(10) Pub. No.: US 2016/0378955 A1
(43) Pub. Date: Dec. 29, 2016

(54) QUANTITATIVE COMPARATIVE ANALYSIS METHOD FOR MOLECULAR ORBITAL DISTRIBUTIONS ACCORDING TO STATE OF CHARGE, AND SYSTEM USING SAME

(71) Applicant: LG CHEM, LTD., Seoul (KR)

(72) Inventors: Seungyup LEE, Daejeon (KR); Hyesung CHO, Daejeon (KR)

(21) Appl. No.: 14/902,438

(22) PCT Filed: Jul. 16, 2014
(86) PCT No.: PCT/KR2014/006426

§ 371 Date: Dec. 31, 2015

(30) Foreign Application Priority Data
Jul. 18, 2013 (KR) 10-2013-0084621

(51) Int. Cl. G06F 19/00

(52) U.S. Cl. CPC G06F 19/701

(57) ABSTRACT

The present invention relates to a quantitative comparative analysis method for molecular orbital distributions that evaluates molecular orbital characteristics according to the neutral, anion and cation state of charge, and a quantitative comparative analysis system for molecular orbital distributions using the method. The present invention provides the advantage of enabling a quantitative comparison to be systematically carried out by representing a difference in molecular orbital distribution by means of a quantitative score, and thus, for a molecular orbital distribution calculated by means of a method based in quantum mechanics, the correlation of the charge-state-specific molecular orbital distribution change can be broken down using vector characteristics formed from three components from an MO-triangle.

### TECHNICAL FIELD

The present invention relates to a novel method for quantitatively analyzing a molecular orbital distribution depending on charge states, and a system using the same. More particularly, the present invention relates to a novel method by which molecular orbital distributions can be quantitatively compared depending on charge states, and a system using the same.

### BACKGROUND ART

Because electron transfer and distribution within molecules are critical factors determining the intrinsic electrochemical properties of materials composed of the molecules, correct knowledge and utilization of intramolecular electron transfer and distribution is absolutely necessary in order to evaluate the properties of materials and develop novel materials having improved properties. The behavior of an electron is expressed as the probability of finding an electron at any specific location. The molecular orbital (MO) concept has been introduced to simulate the behavior of electrons. A molecular orbital, which accounts for the distribution of an electron in a specific region in a molecular structure in a probabilistic manner, cannot be determined experimentally, but can be constructed using the Schrödinger equation based on quantum mechanics.

To date, the quantum-mechanical computation of molecular orbital distributions has been regarded as a qualitative measurement in which 3- or 2-dimensional diagrams created through a contour plot are used for visual comparison. FIG. 1 is a diagram showing the molecular orbital distribution of neutral/HOMO states of NPB (N, N′-Di[(1-naphthyl)-N, N′-diphenyl]-1,1′-(biphenyl)-4,4′-diamine), which is used in an OLED film. To depict FIG. 1, the program Materials Visualizer from Materials Studio for simulating and modeling molecular orbitals was used. In the diagram, the molecular orbital distribution is expressed as regions in which an electron is likely to exist (yellow/green regions). FIG. 1 shows an even molecular orbital distribution over the entire molecule.

As can be seen in this case, however, qualitative measurement through visualization does not provide an accurate criterion for analysis, so that even the same molecular orbital distribution may be analyzed differently. For FIG. 1, by way of example, there may be different estimation results: (1) the molecular orbital is very evenly distributed because the molecular orbital is distributed over the entire molecule, or (2) the molecular orbital is unevenly distributed because the distribution is poor in opposite terminal naphthalene moieties. The problem with such qualitative measurement is more evident when molecular orbital distributions for two molecules, rather than one molecule, are compared to each other. In many materials development cases, electrochemical properties are estimated by comparing the distribution of molecular orbital A with that of molecular orbital B. Since qualitative comparison through visualization may result in greatly different estimation data depending on the criteria, the estimation of two or more molecular orbital distributions is more susceptible to inaccuracy than that of a single molecular orbital distribution. This problem not only arises upon the qualitative comparison of orbital distributions, but is one of the most fundamental limitations for all qualitative approaches. Given an effective, accurate and reliable approach to measuring molecular orbital distribution, which has been estimated only qualitatively to date, materials development can be more effectively achieved with reference to the properties determined by molecular orbital distribution as well as fundamental properties determined by electron transfer, such as electron affinity.

The charge state of a material varies depending on the number of electrons in the valance shell compared to the number of proton(s) in the nucleus. Variation in charge state has a great influence on the electrochemical properties of a material. On the whole, the charge states of a material may be expressed as the following three conditions:

(1) Neutral: the overall charge is 0 (zero) when the number of electrons is identical to that of protons.

(2) Anion: the overall charge is −1 when the number of electrons is greater than that of protons by 1.

(3) Cation: the overall charge is +1 when the number of electrons is less than that of protons by 1.

The behavior and distribution of electrons within molecules changes with the charge state. Hence, molecular orbital distributions, which simulate electron behavior and distribution, are also changed. This change differs from one molecule to another. For example, the overall molecular orbital distribution of material A1 may remain unchanged even in different charge states. Material A2 may greatly change in orbital distribution with the charge stage thereof. As for material A3, its molecular orbital distribution may be greatly changed in a specific charge state. Accordingly, the change of molecular orbital distribution with charge state is predicted to differ from one material to another in a complex manner.

HOMO ((Highest Occupied Molecular Orbital), which has the highest energy in an occupied region, and LUMO (Lowest Unoccupied Molecular Orbital), which has the lowest energy in an unoccupied region, are used to evaluate molecular orbital characteristics because the energy difference between the HOMO and the LUMO is a factor greatly influencing the electrochemical properties of the material. FIG. 2 is a visualization of the data computed using the program MATERIALS STUDIO DMol3 (ACCELRYS) based on Density Functional Theory (DFT). In the molecular structure, regions where molecular orbitals are distributed appear yellow or green, whereas the other regions represent the absence of molecular orbitals. That is, a certain region in which no molecular orbitals are distributed shows a place in which electrons neither exist nor move.

In addition, a change in the charge state of a molecule leads to a change in the orbital distribution of HOMO/LUMO of the molecule. FIG. 3 shows the orbital distributions of HOMO/LUMO of an NPB molecule according to neutral, cationic and anionic charge states thereof.

In FIG. 3, there is a significant deviation in orbital distribution between the HOMO and LUMO for the neutral state, whereas the orbital distributions are similar between the HOMO and LUMO when the molecule has a cationic charge state. On the other hand, the similarity of orbital distributions between the HOMO and LUMO is greater in the anionic state than in the neutral state, and less than in the cationic state. The change of molecular orbital distribution with charge states is an intrinsic characteristic of a material. Systematic comparison and estimation of molecular orbital distributions depending on charge states would reveal electron behaviors that vary with charge states, which is useful for evaluating the electrochemical properties of materials. However, conventional estimation methods are nowhere near being capable of quantitative comparison.

In this regard, Japanese Patent Application Unexamined Publication No. 2011-173821 discloses a novel method for predicting the activity of a new chemical material using the index of reactivity of a molecule, computed on the basis of quantum chemistry calculations in consideration of a reactive molecular orbital as well as a frontier orbital. However, this conventional method is limited in its ability to be applied to the quantitative comparison of molecular orbital distributions between two molecules, particularly depending on charge states.

### DISCLOSURE

### Technical Problem

Accordingly, the present invention has been made keeping in mind the above problems occurring in the prior art, and an object of the present disclosure is to provide a method for quantitatively analyzing molecular orbital distributions depending on charge states.

### Technical Solution

In accordance with an aspect thereof, the present disclosure addresses a method for quantitatively analyzing the molecular orbital distribution of a molecule depending on the neutral, anionic, and cationic charge state thereof, comprising:

a) obtaining a MOD-Dscore value in the following steps i) to iii), the MOD-Dscore value accounting for deviation in the molecular orbital distributions of the HOMO (Highest Occupied Molecular Orbital) and LUMO (Lowest Unoccupied Molecular Orbital) of the molecule in each of neutral, anionic, and cationic charge states:

i) selecting HOMO and LUMO to be compared for molecular orbital distributions of the molecule in each of neutral, anionic, and cationic charge states, and computing molecular orbital distributions using a quantum chemistry calculation,

ii) calculating the structural properties of each molecular orbital by means of a RDM (Radially Discrete Mesh) calculation method, followed by matching with the molecular orbital distributions computed in step i) to obtain molecular orbital distributions according to the structural properties, and

iii) calculating a MOD-Dscore (Molecular Orbital Distribution-Deviation Score) according to the following equation 2 by use of the molecular orbital distribution according to structural property obtained through the two RDMs in step ii);

b) projecting the HOMO and LUMO MOD-Dscore values in each of neutral, anionic, and cationic states onto 3D coordinates; and

c) comparing the HOMO and LUMO MOD-Dscore values in each of neutral, anionic, and cationic states, represented on the 3D coordinates.

MOD-Dscore=1.0−TPD (Equation 2)

(wherein TPD is defined as in the following Equation 3)

$$TPD = \frac{1}{N} {\sum }_{k = 1}^{N} \vert Prof ( {A}_{k} ) - Prof ( {B}_{k} ) \vert \qquad ( Equation 3 )$$

(wherein Prof(Aₖ) and Prof(Bₖ) are molecular orbital values of a respective RDM(k), and N is the total number of RDMs)

Also, the present disclosure addresses a system for quantitatively analyzing molecular orbital distribution depending on charge state, comprising:

a) an MOD-Dscore determining module in which a MOD-Dscore value is obtained through the following steps i) to iii), the MOD-Dscore value accounting for deviation in the molecular orbital distributions of the HOMO (Highest Occupied Molecular Orbital) and LUMO (Lowest Unoccupied Molecular Orbital) of the molecule in each of neutral, anionic, and cationic charge states:

i) selecting HOMO and LUMO to be compared for molecular orbital distributions of the molecule in each of neutral, anionic, and cationic charge states, and computing molecular orbital distributions via a quantum chemistry calculation,

ii) calculating the structural properties of each molecular orbital by means of a RDM (Radially Discrete Mesh) calculation method, followed by matching with the molecular orbital distributions computed in step i) to obtain molecular orbital distributions according to the structural properties, and

iii) calculating a MOD-Dscore (Molecular Orbital Distribution-Deviation Score) according to the following equation 2 by use of the molecular orbital distribution according to structural property obtained through the two RDMs in step ii);

b) a 3-D representation module in which the HOMO and LUMO MOD-Dscore values in neutral, anionic, and cationic charge states of the molecule are projected onto 3D coordinates; and

c) a comparison module in which the HOMO and LUMO molecular orbital distributions in the three charge states, namely neutral, anionic, and cationic, represented on the 3D coordinates, are compared.

### Advantageous Effects

As described hitherto, the quantitative comparative analysis method of molecular orbital distributions evaluates a deviation of molecular orbital distributions as a quantitative score through a profiling method using a MOD-Dscore (Molecular Orbital Distribution-Deviation Score) and a CD-MOT (Charge Dependant-Molecular Orbital Triangle), and thus allows for the systematic, quantitative comparison of molecular orbital distributions computed on the basis of quantum chemistry by specifying correlations between changes in molecular orbital distribution based on charge states by means of vectors composed of three elements constructed using a MO-Triangle. Hence, the method is expected to play a great role in the evaluation of physical properties for the development of novel materials.

### DESCRIPTION OF DRAWINGS

FIG. 1 is a diagram of the structure and molecular orbital distribution of NPB used in some embodiments of the present disclosure.

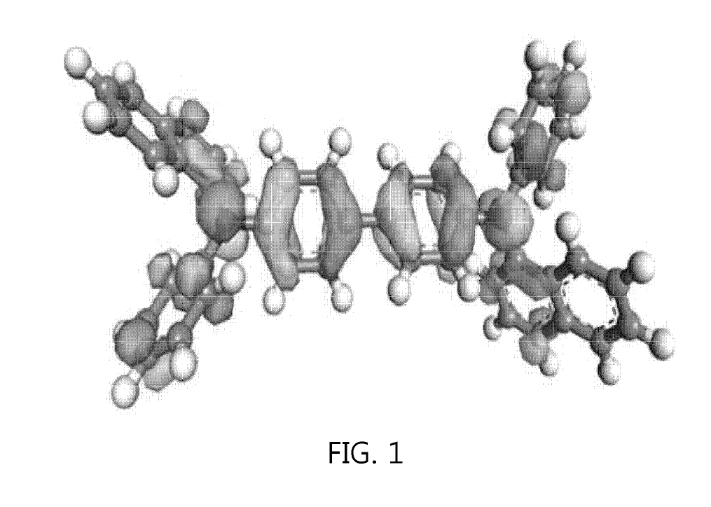

FIG. 2 is a diagram illustrating LUMO molecular orbital distributions of NPB in neutral/cation states used in some embodiments of the present disclosure.

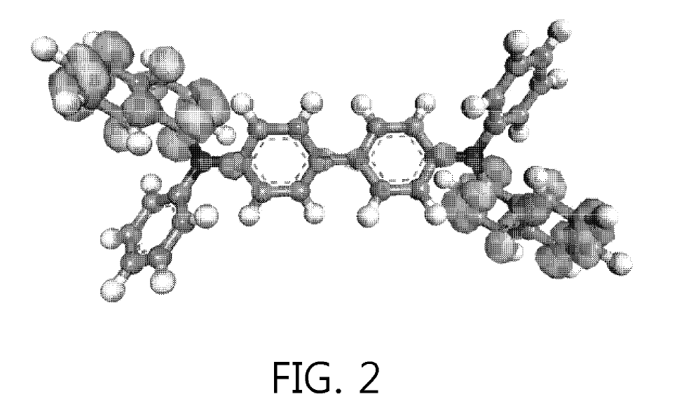

FIG. 3 is a diagram illustrating HOMO-LUMO molecular orbital distributions of NPB in anion, neutral, and cation states used in some embodiments of the present disclosure.

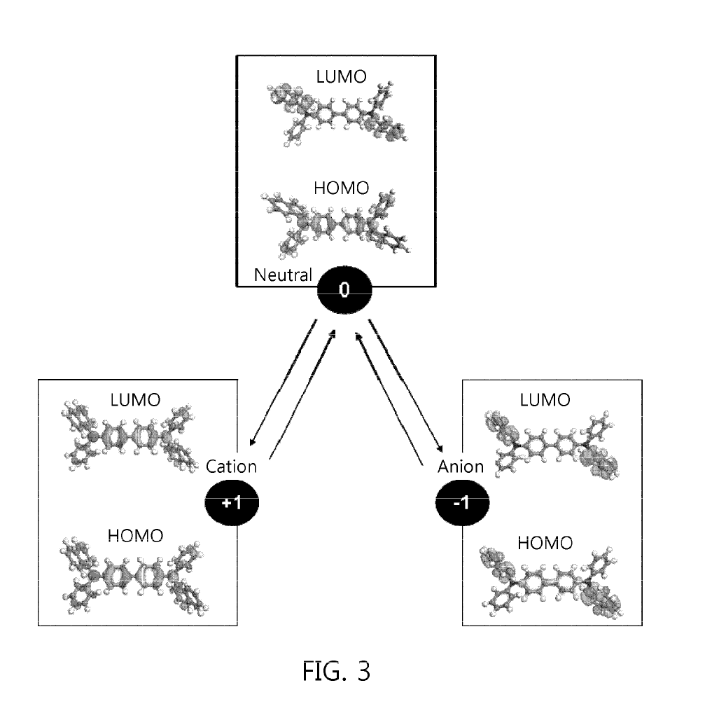

FIG. 4 is a schematic view illustrating RDM calculation.

FIG. 5 is a flow chart illustrating the calculation of CD-MOT according to the present disclosure.

FIG. 6 is a conceptual diagram of 3D coordinates useful in the calculation of CD-MOT.

FIG. 7 is a diagram of 3D coordinates useful in the calculation of CD-MOT according to one embodiment of the present disclosure.

FIG. 8 is a diagram illustrating the procedure for calculating CD-MOT according to one embodiment of the present disclosure.

### BEST MODE

Below, a detailed description will be given of the present invention.

In accordance with an aspect thereof, the present disclosure addresses a method for quantitatively analyzing molecular orbital distribution, comprising: a) selecting HOMO (Highest Occupied Molecular Orbital) and LUMO (Lowest Unoccupied Molecular Orbital) to be compared for molecular orbital distribution and computing molecular orbital distributions in the three charge states, namely neutral, anionic and cationic, through a quantum chemistry calculation, b) calculating the structural properties of each molecular orbital by means of a RDM (Radially Discrete Mesh) calculation method, followed by matching with the HOMO and LUMO molecular orbital distributions in the three (neutral, anionic, and cationic) charge states computed in step a) to obtain the molecular orbital distributions according to the structural properties, and c) comparing the HOMO and LUMO molecular orbital distributions in the three charge states (neutral, anionic, and cationic) according to structural properties, obtained by RDM in step b), using a profiling method.

MOD-Dscore=1.0−TPD 5 (Equation 2)

(wherein TPD is defined as in the following Equation 3)

$$TPD = \frac{1}{N} {\sum }_{k = 1}^{N} \vert Prof ( {A}_{k} ) - Prof ( {B}_{k} ) \vert \qquad ( Equation 3 )$$

(wherein Prof(Aₖ) and Prof(Bₖ) are the molecular orbital values of respective RDM(k), and N is the total number of RDMs)

Herein, the quantitative method of analyzing molecular orbital distributions depending on charge states is designated the “CD-MOT (Charge Dependant-Molecular Orbital Triangle) method”. The CD-MOT method allows for the systematic, quantitative comparison of molecular orbital distributions computed on the basis of quantum chemistry by specifying correlations between changes in molecular orbital distribution with charge states by means of vectors composed of three elements constructed through a MO-Triangle. Hereinafter, the CD-MOT method will be elucidated in detail.

In step a) of the present disclosure, a MOD-Dscore, which can allow for the expression as a digitized value of the deviation in HOMO (Highest Occupied Molecular Orbital) and LUMO (Lowest Unoccupied Molecular Orbital) MO distributions of each of neutral, anionic and cationic states of a molecule, thereby enabling the accurate estimation of molecular orbital distributions in a quantitative manner, is obtained in the following steps i) to iii):

i) selecting two molecular orbitals to be compared for molecular orbital distribution and computing molecular orbital distributions through quantum chemistry calculation;

ii) calculating the structural properties of each molecular orbital by means of a RDM (Radially Discrete Mesh) calculation method, followed by matching with the molecular orbital distributions computed in step i) to obtain molecular orbital distributions according to the structural properties; and

iii) calculating a MOD-Dscore (Molecular Orbital Distribution-Deviation Score) of the following equation 2 using the molecular orbital distribution according to the structural properties obtained in step ii).

In conjunction with the MOD-Dscore calculation, a molecular orbital is defined as a mathematical function describing the wave-like behavior of an electron in a molecule. In the present disclosure, the HOMO (Highest Occupied Molecular Orbital) and LUMO (Lowest Unoccupied Molecular Orbital) to be compared for molecular orbital distribution may be two electron states of one molecule (for example, Neutral/HOMO and Neutral/LUMO for the same molecule). After the HOMO and LUMO molecular orbitals for comparison of molecular orbital distributions are selected, quantum chemistry calculation for each molecular orbital is performed to give HOMO and LUMO molecular orbital distributions in each of neutral, anionic, and cationic states. Any calculation method that takes advantage of quantum chemistry may be employed without limitation to obtain the molecular orbital distributions. Preferable may be calculation through the distribution of the electron density function (ψ2), which is a square of the orbital wave function (ψ), in each point determined in a molecular structure, or through single-point energy calculation or geometry optimization calculation. In detail, the present inventors calculate molecular orbital distributions using the program MATERIALS STUDIO DMol3 (ACCELRYS), which uses the Density Functional Theory (DFT).

In step i), the present disclosure is characterized by calculating the structural properties of each molecular orbital by means of a RDM (Radially Discrete Mesh) calculation method, followed by matching with the HOMO and LUMO molecular orbital distributions, computed in step i), in each of neutral, anionic, and cationic states to obtain molecular orbital distributions according to the structural properties.

The calculation of structural properties can be carried out using (x,y,z) atomic coordinates. This information should be combined with the molecular orbital distributions calculated according to the structural properties. The reason why the calculation of structural properties is needed is that the information about the coordinates of molecular structures is merely data spread over the molecule, which cannot provide any other valuable information. In the present disclosure, hence, the calculation of the structural properties of a given molecule can be accomplished by creating a RDM (Radially Discrete Mesh) starting from the center of the molecule, and then designating regions corresponding to RDMs to compute a RDM accounting for the entire molecular structure. This RDM represents meshes expanding at regular intervals in a radial direction from the center of the molecule. In the calculation of molecular structures by means of RDM, the intramolecular center (x_{c}, y_{c}, z_{c}) is obtained as illustrated by the following Equations 1-1 to 1-3:

$$\begin{matrix}{X}_{C} = \frac{1}{{N}^{AT}} {\sum }_{k = 1}^{{N}^{AT}} {X}_{k} & ( Equation 1 \text{-} 1 ) \\ {Y}_{C} = \frac{1}{{N}^{AT}} {\sum }_{k = 1}^{{N}^{AT}} {Y}_{k} & ( Equation 1 \text{-} 2 ) \\ {Z}_{C} = \frac{1}{{N}^{AT}} {\sum }_{k = 1}^{{N}^{AT}} {Z}_{k} & ( Equation 1 \text{-} 3 )\end{matrix}$$

wherein N^{AT} represents the total number of atomic coordinates constituting the molecule.

Using the RDM method described above, the molecular structure is subdivided, and the subdivided regions are matched with molecular orbital distributions.

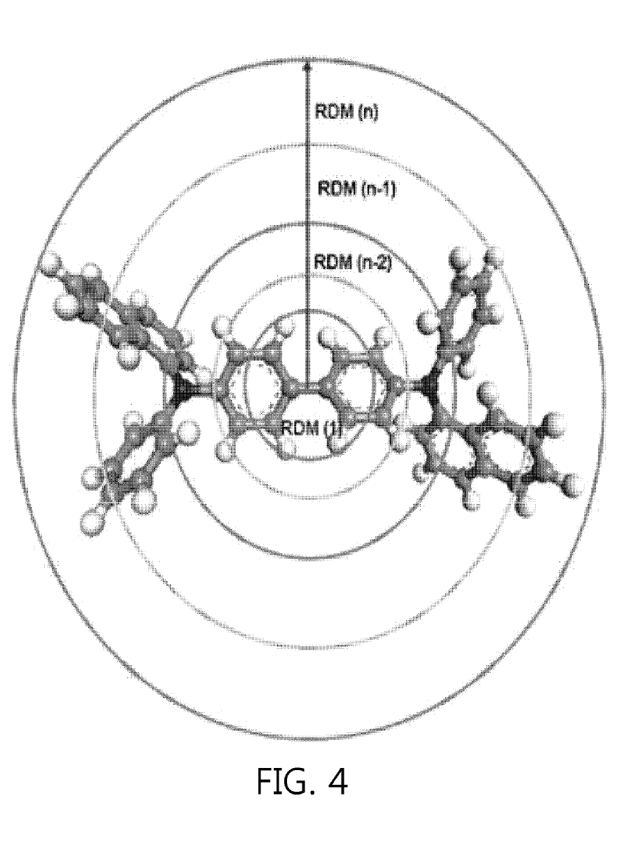

RDM calculation can be further illustrated referring to FIG. 4. RDM increases in the manner RDM(1), RDM(2), . . . , and RDM(n) until all the atoms of the molecular structure are included. Here, RDM(1) is the most proximal to the center of the molecule, while RDM(n) is the outermost RDM, including the entire molecule therein. In the RDM calculation, n, the total number of RDMs, is set to be the same for the HOMO and LUMO molecular orbitals to be compared with each other. No special limitations are imposed on the n values; however, n preferably ranges from 50 to 300, and more preferably from 100 to 300. Molecular orbital distributions are calculated for each of the calculated RDMs. The molecular orbital information calculated with regard to the molecular structure is matched with information on structural properties, converted into a total of n RDMs. The RDM information thus obtained is used for calculating a graph-based profile in step iii) as described later.

Subsequently, the method of the present disclosure proceeds with iii) calculating and comparing the MOD-Dscore (Molecular Orbital Distribution-Deviation Score) according to the following equation 2 by use of the molecular orbital distributions according to the structural properties obtained through the two RDMs in step ii).

In the present disclosure, the calculation of the two RDMs in step ii) can be used to account for the distribution of molecular orbitals with regard to each RDM. This is termed an “RDM-profile”. In the present disclosure, a graph-based profile is created for the molecular orbital distributions matched through the RDM structure characterization of the HOMO and LUMO molecular orbitals, and is used to calculate the profile deviation in the molecular orbital distribution of the graph. That is, the deviation of molecular orbital distribution in each RDM is calculated with regard to the entire structure. The profile deviation in one RDM ranges from 0 to 1.0. When the profile deviation is 0 (zero), the two profiles are identical. A greater profile deviation means that the two profiles are more different. As such, a profile comparison method can indicate the quantitative deviation of the molecular orbital distributions that are matched with regard to structures according to HOMO and LUMO molecular orbitals via each RDM. This can be further embodied by obtaining the TPD (Total Profile Deviation) of Equation 3, which represents the sum of all the RDMs:

$$TPD = \frac{1}{N} {\sum }_{k = 1}^{N} \vert Prof ( {A}_{k} ) - Prof ( {B}_{k} ) \vert \qquad ( Equation 3 )$$

(wherein Prof(Aₖ) and Prof(Bₖ) are the molecular orbital values of respective RDM(k), and N is the total number of RDMs.)

Using the TPD value, a MOD-Dscore, by which the deviation between HOMO and LUMO molecular orbital distributions can be further quantitatively compared, can be calculated according to the following Equation 3:

MOD-Dscore=1.0−TPD (Equation 2)

The calculated values of MOD-Dscore are between 0.0 and 1.0. When HOMO and LUMO molecular orbital distributions are exactly identical, TPD has a value of 0.0, and thus the MOD-Dscore is 1.0. Greater deviation between HOMO and LUMO molecular orbital distributions makes the MOD-Dscore smaller than 1.0. As such, the distribution deviation between HOMO and LUMO molecular orbitals can be quantitatively analyzed based on the MOD-Dscore.

In the method for quantitatively analyzing molecular orbital distribution depending on charge states in accordance with the present disclosure, HOMO and LUMO MOD-Dscore values in neutral, anionic, and cationic states, computed based on MOD-Dscores, can be positioned in 3D coordinates.

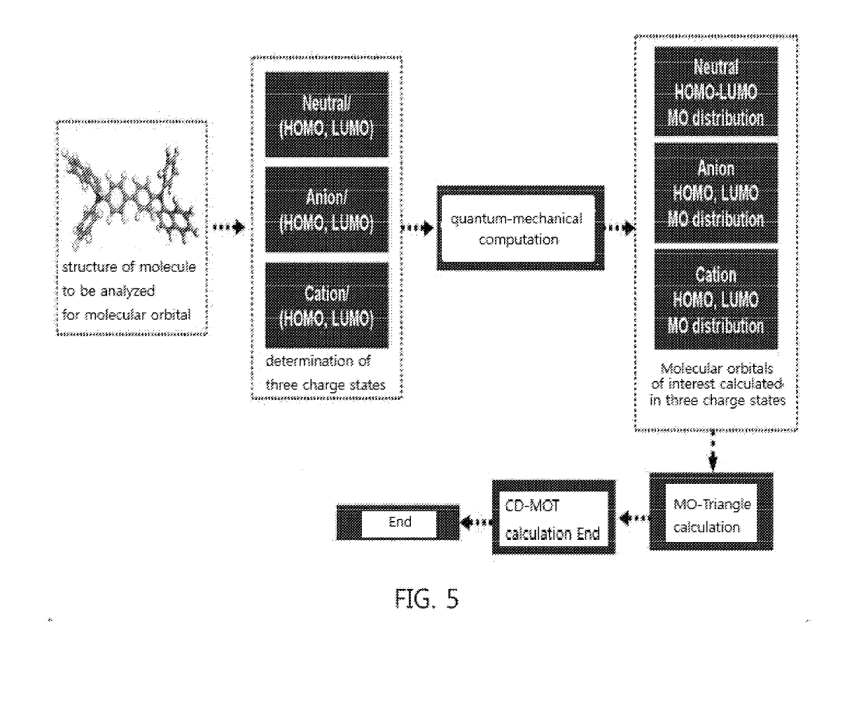

To this end, the present inventors have developed a CD-MOT (Charge Dependant-Molecular Orbital Triangle), with which the correlation of molecular orbital distributions in each charge state can be calculated. CD-MOT is designed to estimate changes in molecular orbital distributions by calculating the correlation of orbital distributions of HOMO-LUMO depending on three (neutral, anionic, and cationic) charge states. FIG. 5 is a flow chart illustrating the process of calculating CD-MOD. With reference to FIG. 5, CD-MOT is calculated as follows:

(1) Computation of Molecular Orbitals with Regard to Three Charge States Using Quantum Mechanics

HOMO and LUMO molecular orbital distributions in the three charge states (neutral/anionic/cationic) of a material of interest are computed using quantum chemistry calculation. In detail, HOMO and LUMO molecular orbital distributions in three charge states are calculated using the program MATERIALS STUDIO DMol3, which was developed on the basis of the Density Functional Theory (DFT) by ACCELRYS.

(2) MO-Triangle Calculation:

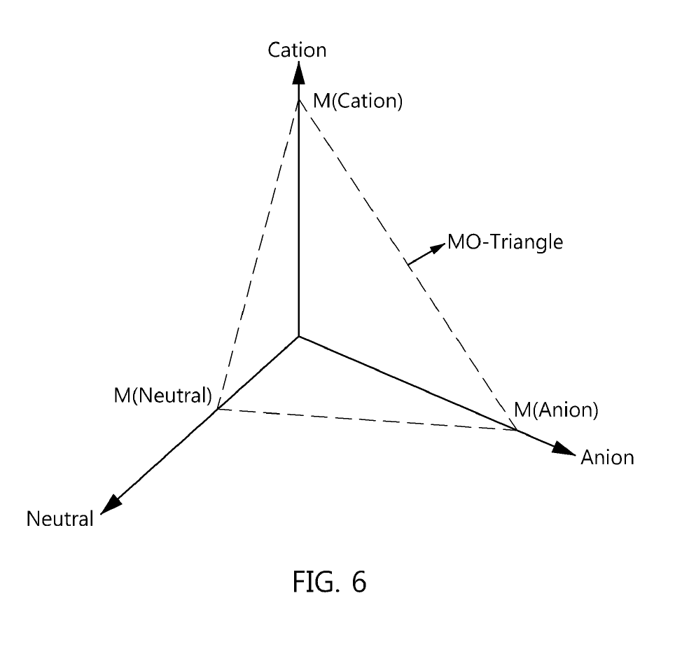

The quantitative differences of calculated HOMO and LUMO molecular orbital distributions in the three charge states are calculated by means of the MOD-Dscores. When the HOMO and LUMO molecular orbital distributions are exactly the same, the MOD-Dscore value is 1.0. Greater deviation between HOMO and LUMO molecular orbital distributions makes the MOD-Dscore smaller than 1.0. As such, the distribution deviation between HOMO and LUMO molecular orbitals can be quantitatively analyzed based on the MOD-Dscore. Thus, the MOD-Dscore is limited to the domain: 0.0<MOD-Dscore≦1.0. Respective MOD-Dscore values are calculated for the three states. The HOMO and LUMO MOD-Dscore values for neutral, anionic, and cationic states can be expressed as vectors of (M (neutral), M (anionic), and M (cationic)) on 3D coordinates, as can be seen in FIG. 6.

In FIG. 6, Ms (neutral, anionic and cationic) represent calculated HOMO and LUMO MOD-Dscore values in neutral, anionic and cationic states. For this, a three-dimensional MO space composed of x-axis (neutral), y-axis (anionic), and z-axis (cationic) may be established. These three elements are connected with one another to form a triangle, termed a “MO-Triangle” (Molecular Orbital-Triangle). The MO-Triangle exhibits a vector characteristic composed of (M (Neutral), M (Anionic), and M (Cationic)).

(3) CD-MOT Calculation:

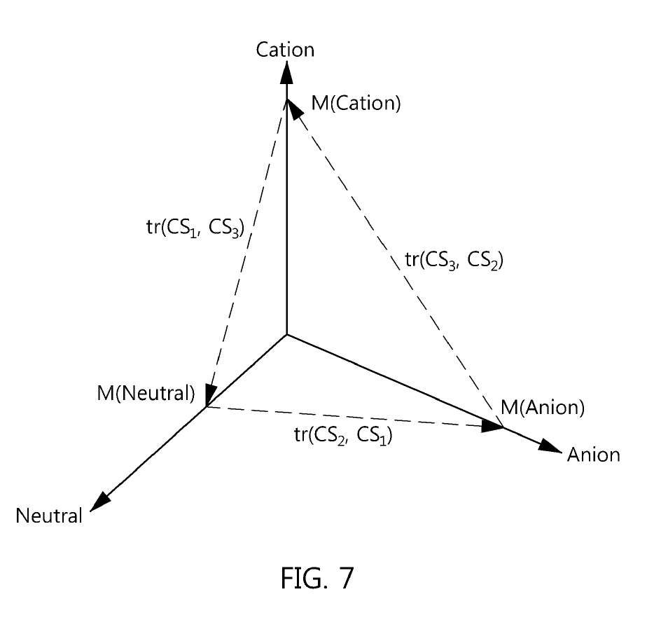

The MO-Triangle accounts for the quantitation of the deviation of molecular orbital distributions among the three charge states. In order to understand the change of molecular orbital distribution with charge state, correlation of the distributions is calculated using CD-MOT (Charge Dependant-Molecular Orbital Triangle), as shown in FIG. 7.

CD-MOT can be represented as the following Equation 4:

CD-MOT=(tr(CS₂,CS₁),tr(CS₃,CS₂),tr(CS₁,CS₃)) (Equation 4)

(wherein tr(CSₓ, CS_{y})=M(CSₓ)/M(CS_{y}), M(CSₓ) is a MOD-Dscore value for HOMO and LUMO in a CSₓ state, CS1 represents a neutral state, CS₂ is an anionic state, and CS₃ is a cationic state)

The condition that tr(CSₓ, CS_{y}) of CD-MOT is 1.0 explains that the molecular orbital distribution remains unchanged, but similar, as the charge state shifts from CSₓ to CS_{y}. On the other hand, tr(CSₓ, CS_{y}) of CD-MOT greater or smaller than 1.0 means that the molecular orbital distribution varies with the charge state. Hence, CD-MOT can calculate the correlation of orbital distributions of HOMO and LUMO depending on three (neutral, anionic, and cationic) charge states, thereby estimating changes in molecular orbital distributions.

In accordance with another aspect thereof, the present disclosure addresses a system for quantitatively analyzing molecular orbital distribution depending on charge state, using the quantitative analysis method described above.

The quantitative analysis system for molecular orbital distributions, adapted to estimating molecular orbital distributions of a molecule depending on its neutral, anionic, and cationic charge states, comprises:

a) an MOD-Dscore determining module in which a MOD-Dscore value is obtained by the following steps i) to iii), the MOD-Dscore value accounting for deviation in the molecular orbital distributions of the HOMO (Highest Occupied Molecular Orbital) and LUMO (Lowest Unoccupied Molecular Orbital) of the molecule in each of neutral, anionic, and cationic charge states:

i) selecting HOMO and LUMO to be compared for molecular orbital distributions of the molecule in each of neutral, anionic, and cationic charge states, and computing molecular orbital distributions through a quantum chemistry calculation,

ii) calculating the structural properties of each molecular orbital by means of a RDM (Radially Discrete Mesh) calculation method, followed by matching with the molecular orbital distributions computed in step i) to obtain molecular orbital distributions according to the structural properties thereof, and

iii) calculating a MOD-Dscore (Molecular Orbital Distribution-Deviation Score) according to the following equation 2 by use of the molecular orbital distribution according to the structural properties obtained through the two RDMs in step ii);

b) a 3-D representation module in which the HOMO and LUMO MOD-Dscore values in neutral, anionic, and cationic charge states of the molecule are projected onto 3D coordinates; and

c) a comparison module in which the HOMO and LUMO molecular orbital distributions in the three charge states (neutral, anionic, and cationic), represented on the 3D coordinates, are compared:

MOD-Dscore=1.0−TPD (Equation 2)

(wherein TPD is defined as in the following Equation 3)

$$TPD = \frac{1}{N} {\sum }_{k = 1}^{N} \vert Prof ( {A}_{k} ) - Prof ( {B}_{k} ) \vert \qquad ( Equation 3 )$$

(wherein Prof(Aₖ) and Prof(Bₖ) are the molecular orbital values of respective RDM(k), and N is the total number of RDMs.)

In the MOD-Dscore determining module, the quantum chemistry calculation can be conducted through the distribution of the electron density function (ψ2), which is a square of the orbital wave function (ψ), in each point determined preferably in single-point energy calculation or geometry optimization calculation, as described in the quantitative method of analyzing molecular orbital distribution.

In the MOD-Dscore determining module, the calculation of structural properties can be carried out using (x,y,z) atomic coordinates, as described in the quantitative method of analyzing molecular orbital distributions. The calculation of structural properties of a given molecule can be accomplished by creating a RDM (Radially Discrete Mesh).

As described in the quantitative method of analyzing molecular orbital distributions, the RDM calculation is characterized in that the molecular orbital distributions included within each RDM are matched to give RDM information.

The total number (N) of RDMs used in the RDM (Radially Discrete Mesh) calculation method may preferably range from 50 to 300, and more preferably from 100 to 300.

In the MOD-Dscore determining module, the HOMO and LUMO molecular orbital distributions in the neutral, anionic, and cationic charge states of a molecule can be compared using a profiling method, as described in the quantitative method of analyzing molecular orbital distributions.

The profiling method for structural property calculation in the MOD-Dscore determining module may employ TPD (Total Profile Deviation), as represented by the following Equation 3.

$$TPD = \frac{1}{N} {\sum }_{k = 1}^{N} \vert Prof ( {A}_{k} ) - Prof ( {B}_{k} ) \vert \qquad ( Equation 3 )$$

(wherein Prof(Aₖ) and Prof(Bₖ) are the molecular orbital values of respective RDM(k), and N is the total number of RDMs.)

Further, the structural property calculation in the MOD-Dscore determining module may utilize MOD-Dscore as represented by the following Equation 2:

MOD-Dscore=1.0−TPD (Equation 2)

In addition, the quantitative analysis system of molecular orbital distributions depending on charge states proceeds to calculate HOMO and LUMO MOD-Dscore values in neutral, anionic, and cationic charge states by means of a RDM calculation method and to represent the values on 3-D coordinates. For this, the CD-MOT values of Equation 4 can be used.

As used herein, the term “module” means a unit in which a certain function or action is processed, and may be embodied by hardware or software or a combination of hardware and software.

### MODE FOR INVENTION

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

### EXAMPLE

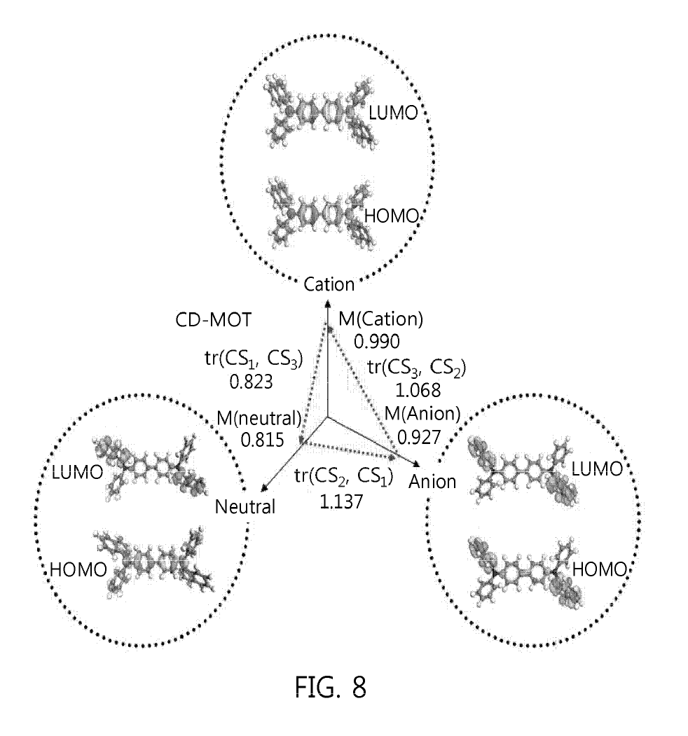

Quantitative comparison was made of molecular orbital distribution deviation depending on charge states. In this regard, CD-MOT was applied, as shown in FIG. 8, to the quantitative comparison of molecular orbital distribution deviations between HOMO and LUMO in the three (neutral, anionic, and cationic) states of an NPB molecule, using the MOD-Dscore developed in the present invention. For calculating molecular orbital distributions, MATERIALS STUDIO DMol3 (ACCELRYS) was employed, wherein n for the RDM calculation was set to be 200.

### Example 1

### Comparison of Molecular Orbital Deviation Between HOMO and LUMO in Neutral/Anionic/Cationic States

As shown in FIG. 8, quantitative comparison was made of molecular orbital distributions. As a result of the quantitative estimation, the MOD-Dscore between HOMO and LUMO was measured to be 0.815, which is less than 1.0, in a neutral state, 0.927 in an anionic state, and 0.990, which approaches 1, in a cationic state.

These MOD-Dscore values in neutral, anionic, and cationic states are projected onto the 3D-MO space of the present disclosure to give MO-Triangle=(0.815, 0.927, 0.990). On the basis of this MO-Triangle, CD-MOT is calculated as CD-MOT=(1.137, 1.068, 0.823).

As is understood from the calculated CD-MOT values, NPB has similar molecular orbital distributions in anionic-cationic states because tr(CS₃, CS₂) is 1.068, which is close to 1. For neutral-anionic states and neutral-cationic states, the values are respectively measured to be 1.137 and 0.823, which are much larger or smaller than 1.0, demonstrating that molecular orbital distributions depend greatly on charge states.

In contrast, the molecular orbital distribution of a certain molecule may not vary depending on the charge state thereof. As such, the molecule orbital distributions depending on charge states are intrinsic properties of electron behaviors of materials. The CD-MOT of the present invention allows for the systematic estimation of molecular orbital distributions depending on charge states, and thus is expected to play a great role in evaluating physical properties in the development of novel materials.

1. A method for quantitatively analyzing a molecular orbital distribution of a molecule depending on neutral, anionic, and cationic charge state thereof, comprising:
a) obtaining a MOD-Dscore value in the following steps i) to iii), the MOD-Dscore value accounting for a deviation in molecular orbital distributions of a HOMO (Highest Occupied Molecular Orbital) and a LUMO (Lowest Unoccupied Molecular Orbital) of the molecule in each of neutral, anionic, and cationic charge states:
i) selecting HOMO and LUMO to be compared for molecular orbital distributions of the molecule in each of neutral, anionic, and cationic charge states, and computing molecular orbital distributions through a quantum chemistry calculation,
ii) calculating structural properties of each molecular orbital by means of a RDM (Radially Discrete Mesh) calculation method, followed by matching with the molecular orbital distributions computed in step i) to obtain molecular orbital distributions according to the structural properties, and
iii) calculating a MOD-Dscore (Molecular Orbital Distribution-Deviation Score) according to the following equation 2 by use of the molecular orbital distributions according to structural properties obtained through the two RDMs in step ii);
b) projecting the HOMO and LUMO MOD-Dscore values in each of neutral, anionic, and cationic states onto 3D coordinates; and
c) comparing the HOMO and LUMO MOD-Dscore values in each of neutral, anionic, and cationic states, represented on the 3D coordinates:
MOD-Dscore=1.0−TPD (Equation 2)
(wherein TPD is defined as in the following Equation 3)
$$TPD = \frac{1}{N} {\sum }_{k = 1}^{N} \vert Prof ( {A}_{k} ) - Prof ( {B}_{k} ) \vert \qquad ( Equation 3 )$$
(wherein Prof(Aₖ) and Prof(Bₖ) are molecular orbital values of respective RDM(k), and N is a total number of RDMs).

2. The method of claim 1, wherein the quantum chemistry calculation of step i) is conducted through distribution of the electron density function (ψ2), which is a square of the orbital wave function (ψ), in each point determined with regard to a molecular structure.

3. The method of claim 1, wherein the quantum chemistry calculation of step i) is conducted through single-point energy calculation or geometry optimization calculation.

4. The method of claim 1, wherein the calculation of structural properties of step ii) is carried out using (x,y,z) atomic coordinates.

5. The method of claim 1, wherein the RDM (Radially Discrete Mesh) calculation method of step ii) is carried out by creating meshes that are structured to expand at regular intervals in a radial direction, starting from a center of a molecule.

6. The method of claim 5, wherein the RDM (Radially Discrete Mesh) calculation method of step ii) employs a total number (N) of 50 to 300 of RDM.

7. The method of claim 5, wherein the RDM (Radially Discrete Mesh) calculation method of step ii) employs a total number (N) of 100 to 300 of RDM.

8. The method of claim 1, wherein the MOD-Dscore values of HOMO and LUMO in each of neutral, anionic, and cationic states in step b) are represented as a vector (M (neutral), M (anionic), M (cationic)).

9. The method of claim 1, wherein step c) comprises calculating CD-MOT according to the following Equation 4:
CD-MOT=(tr(CS₂,CS₁),tr(CS₃,CS₂),tr(CS₁,CS₃)) (Equation 4)
(wherein tr(CSₓ, CS_{y})=M(CSₓ)/M(CS_{y}), M(CSₓ) is a MOD-Dscore value for HOMO and LUMO in a CSₓ state, CS₁ represents a neutral state, CS₂ is an anionic state, and CS₃ is a cationic state).

10. A system for quantitatively analyzing a molecular orbital distribution depending on charge state, comprising:
a) a MOD-Dscore determining module in which a MOD-Dscore value is obtained through the following steps i) to iii), the MOD-Dscore value accounting for deviation in molecular orbital distributions of HOMO (Highest Occupied Molecular Orbital) and LUMO (Lowest Unoccupied Molecular Orbital) of a molecule in each of neutral, anionic, and cationic charge states:
i) selecting HOMO and LUMO to be compared for molecular orbital distributions of the molecule in each of neutral, anionic, and cationic charge states, and computing molecular orbital distributions through a quantum chemistry calculation,
ii) calculating structural properties of each molecular orbital by means of a RDM (Radially Discrete Mesh) calculation method, followed by matching with the molecular orbital distributions computed in step i) to obtain molecular orbital distributions according to the structural properties, and
iii) calculating a MOD-Dscore (Molecular Orbital Distribution-Deviation Score) of the following equation 2 by use of the molecular orbital distribution according to the structural properties obtained through the two RDMs in step ii);
b) a 3-D representation module in which MOD-Dscore values of HOMO and LUMO in neutral, anionic, and cationic charge states of the molecule are projected onto 3D coordinates; and
c) a comparison module in which the molecular orbital distributions of HOMO and LUMO in the three charge states of neutral, anion, and cation, represented on the 3D coordinates, are compared:
MOD-Dscore=1.0−TPD (Equation 2)
(wherein TPD is defined as in the following Equation 3)
$$TPD = \frac{1}{N} {\sum }_{k = 1}^{N} \vert Prof ( {A}_{k} ) - Prof ( {B}_{k} ) \vert \qquad ( Equation 3 )$$
(wherein Prof(Aₖ) and Prof(Bₖ) are molecular orbital values of respective RDM(k), and N is a total number of RDMs).

11. The system of claim 10, wherein the quantum chemistry calculation of the MOD-Dscore determining module is conducted through the distribution of the electron density function (ψ2), which is a square of the orbital wave function (ψ), in each point determined with regard to a molecular structure.

12. The system of claim 10, wherein the quantum chemistry calculation of the MOD-Dscore determining module is conducted through single-point energy calculation or geometry optimization calculation.

13. The system of claim 10, wherein the calculation of structural properties of the MOD-Dscore determining module is carried out using (x,y,z) atomic coordinates.

14. The system of claim 10, wherein the RDM (Radially Discrete Mesh) calculation method of the MOD-Dscore determining module is carried out by creating meshes that are structured to expand at regular intervals in a radial direction, starting from a center of a molecule.

15. The system of claim 10, wherein the RDM (Radially Discrete Mesh) calculation method of the MOD-Dscore determining module employs a total number (N) of 50 to 300 of RDM.

16. The method of claim 15, wherein the RDM (Radially Discrete Mesh) calculation method of the MOD-Dscore determining module employs a total number (N) of 100 to 300 of RDM.

17. The system of claim 10, wherein the MOD-Dscore values of HOMO and LUMO in each of neutral, anionic, and cationic states in step b) are represented as a vector (M (neutral), M (anionic), M (cationic)).

18. The system of claim 10, wherein the comparison module is designed to calculate CD-MOT according to the following Equation 4:
CD-MOT=(tr(CS₂,CS₁),tr(CS₃,CS₂),tr(CS₁,CS₃)) (Equation 4)
(wherein tr(CSₓ, CS_{y})=M(CSₓ)/M(CS_{y}), M(CSₓ) is a MOD-Dscore value for HOMO and LUMO in a CSₓ state, CS₁ represents a neutral state, CS₂ is an anionic state, and CS3 is a cationic state).
